(19) United States
(12) Patent Application Publication
(10) Pub. No.: US 2015/0208832 A1
(43) Pub. Date: Jul. 30, 2015

(54) TRAILER HITCH COUPLER DISPLAY STAND

(71) Applicant: WINSTON PRODUCTS LLC, Cleveland, OH (US)

(72) Inventors: Colleen Renee Kurniawan, Cleveland, OH (US); Winston Breeden, III, Chagrin Falls, OH (US)

(73) Assignee: WINSTON PRODUCTS LLC, Cleveland, OH (US)

(21) Appl. No.: 14/168,034

(22) Filed: Jan. 30, 2014

(51) Int. Cl. A47F 7/00; B60D 1/06

(52) U.S. Cl. CPC A47F 7/00; B60D 1/06

(57) ABSTRACT

An apparatus includes a trailer hitch coupler and a stand. The coupler includes a ball receiving portion and a mounting portion. The mounting portion has a pair of substantially parallel extending sides connected by a span and attachment structure enabling attachment to a trailer frame. The stand has a base. A pair of substantially parallel stand sides extend from the base and are adapted to engage a respective exterior side of the mounting portion of the trailer hitch coupler. A stand attachment portion extends from the base in the same direction as the sides. The stand attachment portion is adapted to engage the exterior of the span of the mounting portion. Locking structure for interaction with the attachment structure of the mounting portion such that the trailer hitch coupler is supported to extend in an orthogonal direction from the base.

### TECHNICAL FIELD

The present application relates generally to displaying merchandise. In particular, the instant application relates to displaying a trailer hitch coupler for retail sale.

### BACKGROUND OF THE INVENTION

Trailer towing components, such as trailer hitch couplers, are often stored and offered for retail sale in or on merchandising display structures such as bins, racks, shelves, and the like. One or more labels are typically adhered to the trailer hitch coupler. The labels have important identifying information about the specific trailer hitch coupler they are attached to. The identifying information typically includes hitch ball size, class, maximum trailer weight, part number, UPC code, trade name, manufacturer and the like.

Components used for trailer hitch couplers are typically constructed of steel and are relatively heavy. Thus, trailer hitch couplers are relatively cumbersome to conveniently display. As a result, the trailer hitch couplers are often haphazardly arranged in the merchandising display structures. Such haphazard arrangement can cause the trailer hitch couplers to engage one another. This engagement may cause damage to the trailer hitch couplers and, in most particularly, to the labels that are attached to the trailer hitch couplers.

A damaged label could cause retail customers confusion as to the correct trailer hitch coupler to buy, dissatisfaction if they purchase the wrong size class or maximum weight category and even a complete loss of sale. Such damaged labels could cause retailers problems by not knowing how many particular trailer hitch couplers have been sold, that remain in stock or even the price. Thus, it is desirable to provide a new way to display a trailer hitch coupler.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

A stand for receiving and displaying a trailer hitch coupler is provided according to one embodiment or aspect. The trailer hitch coupler has a ball receiving portion and a mounting portion extending from the ball receiving portion. The mounting portion of the trailer hitch coupler has a pair of substantially parallel extending sides connected by a span. The mounting portion also has attachment structure enabling attachment to a trailer frame. The stand comprises a base. A pair of substantially parallel stand sides extends from the base. At least a portion of each of the pair of stand sides is located to engage a respective side of the mounting portion of the trailer hitch coupler. A stand attachment portion extends from the base in the same direction as the stand sides. The stand attachment portion is located to engage a surface of the mounting portion of the trailer hitch coupler. Locking structure is provided for interaction with the attachment structure of the mounting portion of the trailer hitch coupler to operatively attach the stand to the trailer hitch coupler and support the trailer hitch coupler in a predetermined relationship with the stand.

A stand for receiving and displaying a trailer hitch coupler is provided according to another embodiment or aspect. The trailer hitch coupler has a ball receiving portion and a mounting portion extending from the ball receiving portion. The mounting portion has a pair of substantially parallel extending sides connected by a span. The mounting portion also has attachment structure enabling attachment to a trailer frame. The stand comprises a base. A pair of substantially parallel stand sides extends from the base. Each of the pair of stand sides is adapted to engage a respective exterior side of the mounting portion. A stand attachment portion extends from the base in the same direction as the stand sides and is located between the stands sides and connects the stands sides. The stand attachment portion is adapted, to engage the exterior of the span of the mounting portion of the trailer hitch coupler. Interior support structure extends from the base in the same direction as the stand sides. The interior support structure is located to engage an interior surface of the mounting portion of the trailer hitch coupler. Resiliently deformable locking structure is provided on the stand attachment portion for interaction with the attachment structure of the mounting portion of the trailer hitch coupler when the trailer hitch coupler is received by the stand.

An apparatus according to another embodiment or aspect comprises a trailer hitch coupler. The trailer hitch coupler includes a ball receiving portion. A mounting portion extends from the ball receiving portion. The mounting portion has a pair of substantially parallel extending sides connected by a span. The mounting portion also has attachment structure enabling attachment to a trailer frame. The apparatus also comprises a stand for receiving the trailer hitch coupler. The stand has a base. A pair of substantially parallel stand sides extends from the base. Each of the pair stand sides is adapted to engage a respective exterior side of the mounting portion of the trailer hitch coupler. A stand attachment portion extends from the base in the same direction as the stand sides. The stand attachment portion is located to engage the exterior of the span of the mounting portion of the trailer hitch coupler. Locking structure is provided for interaction with the attachment structure of the mounting portion of the trailer hitch coupler whereby the trailer hitch coupler is supported to extend in an orthogonal direction from the base.

The following description and annexed drawings set forth certain illustrative embodiments, aspects and implementations. These are indicative of but a few of the various ways in which one or more aspects can be employed. Other aspects, advantages, and novel features of the disclosure will become apparent from the following detailed description when considered in conjunction with the annexed drawings.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a perspective view of a display stand, according to one example embodiment, supporting a trailer hitch coupler;

FIG. 2 is an enlarged cross-sectional view of the stand and trailer hitch coupler illustrated in FIG. 1 and taken approximately along line 2-2 of FIG. 1;

FIG. 3 is an enlarged cross-sectional view of the stand and trailer hitch coupler illustrated in FIG. 1 and taken approximately along line 3-3 of FIG. 1;

FIG. 4 is an enlarged perspective top view of the stand illustrated in FIG. 1:

FIG. 5 is an enlarged perspective bottom view of the stand illustrated in FIG. 4;

FIG. 6 is a side elevation view of the stand illustrated in FIG. 4 taken approximately along line 6-6 of FIG. 4;

FIG. 7 is a front elevation view of the stand illustrated in FIG. 6 taken approximately along line 7-7 of FIG. 6;

FIG. 8 is a rear elevation view of the stand illustrated in FIG. 6 taken approximately along line 8-8 of FIG. 6;

FIG. 9 is a bottom view of the stand illustrated in FIG. 8 taken approximately along line 9-9 of FIG. 8; and

FIG. 10 is a top view of the stand illustrated in FIG. 8 and taken approximately along line 10-10 of FIG. 8.

### DETAILED DESCRIPTION OF THE INVENTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It will be apparent, however, that the claimed subject matter can be practiced without these specific details.

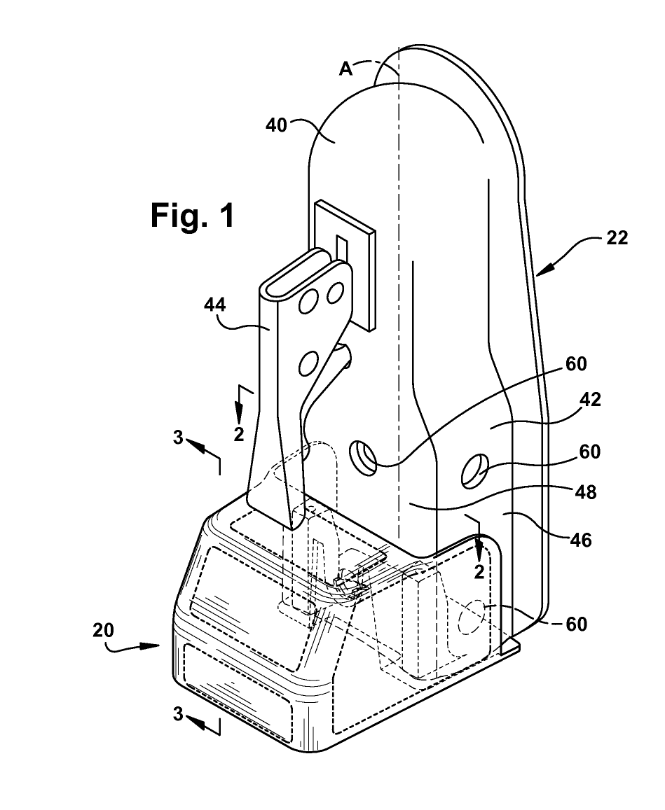

An example display stand 20, according to one embodiment or aspect, is illustrated in FIG. 1 for receiving and supporting an example trailer hitch coupler 22 for retail merchandising. The stand 20 is intended to support the trailer hitch coupler 22 on a retail shelf so the trailer hitch coupler extends in a substantially vertical direction. The stand 20, thus, overcomes some of the previous disadvantages of prior ways to display the trailer hitch coupler 22 for retail sales. Specifically, the stand 20 displays the trailer hitch coupler 22 in such a manner that it does not engage adjacent trailer hitch couplers to minimize damage to other trailer hitch couplers and/or labels that are affixed to the trailer hitch couplers or similar. Also, neat organization is easily achieved for appearance, space utilization or similar. Still further, indicia that may be present on the stand 20 and/or the trailer hitch coupler 22 is oriented is a predetermined manner, so as to allow ease of viewing or similar.

The trailer hitch coupler 22 is intended to be attached to a utility trailer frame (not shown) so the trailer may be towed by a vehicle. The trailer hitch coupler 22 has a longitudinally extending axis A. When the trailer hitch coupler 22 is received in the stand 20 and the stand placed on a substantially horizontally arranged retail shelf, the axis A will extend in a substantially vertical direction.

The trailer hitch coupler 22 has a ball receiving portion 40, as is known, for receiving a hitch ball that is fixed to a towing vehicle. The trailer hitch coupler 22 also has a mounting portion 42 that extends from the ball receiving portion 40. The ball receiving portion 40 and the mounting portion 42 of the trailer hitch coupler 22 can be formed integrally as one-piece from a suitable material such galvanized steel. The trailer hitch coupler 22 can be formed by any suitable process, such as by stamping or forging. The trailer hitch coupler 22 may be of any suitable size and shape. The trailer hitch coupler 22 can also be of any suitable “class” that is appropriate for towing a trailer of a particular weight and hitch ball size.

The trailer hitch coupler 22 also typically includes a ball receiving retainer mechanism 44. The retainer mechanism 44 can be actuated between conditions to alternatively hold the hitch ball in the ball receiving portion 42 of the trailer hitch coupler 22 or release the hitch ball from the ball receiving portion. The retainer mechanism 44 may include structure, such as openings, to receive a lock that will keep the retainer mechanism 44 in a desired condition.

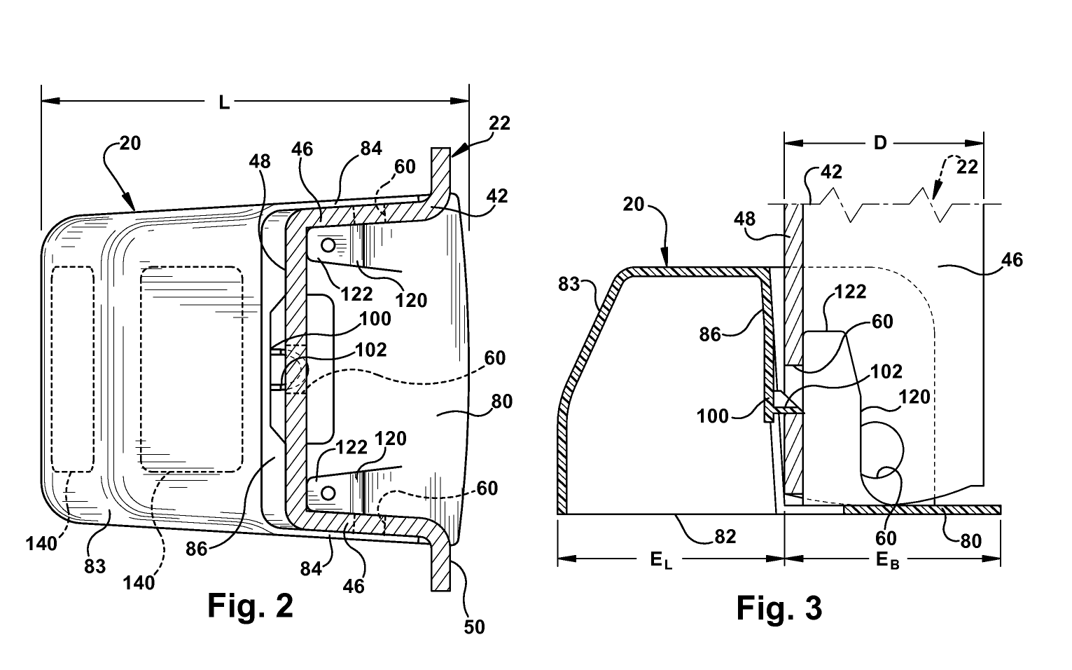

The mounting portion 42 of the trailer hitch coupler 22 includes a pair of substantially parallel extending sides 46, best seen in FIG. 2. While the sides 46 are illustrated as being slightly skewed from one another it will be appreciated that being described as “substantially parallel extending” also is intended to encompass the sides 46 extending at a slight angle relative to one another. The sides 46 of the mounting portion 42 of the trailer hitch coupler 22 are connected by a span 48 to form a U-shaped channel. The entire periphery of the trailer hitch coupler 22 may have a flange 50 extending outwardly for a short distance.

The mounting portion 42 of the trailer hitch coupler 22 also includes attachment structure 60 that enables attachment of the trailer hitch coupler to the utility trailer frame. The attachment structure 60 may be in the form of a plurality of openings. Such openings align with like openings on the utility trailer frame to enable attachment and/or removal and replacement of the trailer hitch coupler 22. However, it will be apparent that any suitable form of attachment structure 60 may be employed.

The stand 20 includes a base 80 (best seen in FIGS. 2-5) that extends for a distance E_{B} (FIG. 3). The base 80 has a substantially planar peripheral portion 82 and an open cavity or hollow portion 83 (best seen in FIG. 5). The peripheral portion 82 extends from the base 80 for a distance E_{L} (FIG. 3). The base 80 of the stand 20, thus, has an overall length L (FIG. 2). The peripheral portion 82 of the base 80 can be integrally molded as one-piece with the base 80 from a suitable plastic material. The base 80 and peripheral portion 82 act to receive, support and maintain the trailer hitch coupler 22 in an upright orientation, as illustrated in FIG. 1.

The base 80 and peripheral portion 82 of the stand 20 are intended to rest on a substantially flat and substantially horizontal surface, such as a retail merchandising shelf. The exterior of the hollow portion 83 may take any suitable shape and configuration that compliments and completes the remainder of the stand 20. It will also be apparent that the hollow portion 83 may be closed or filled with suitable material, such as the plastic used in the construction of the stand 20.

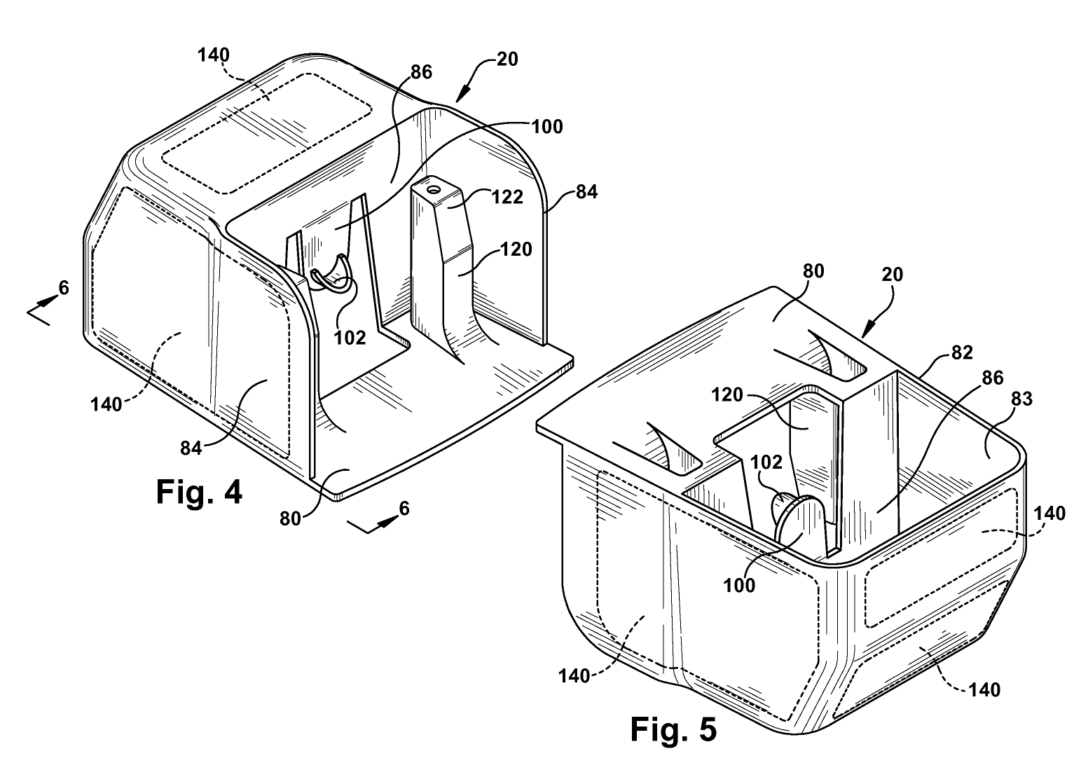

The base 80 of the stand 20 has a pair of substantially parallel extending stand sides 84 (FIGS. 2 and 4) that extend in the same direction from the base. While the stand sides 84 are shown as being slightly skewed from one another it will be appreciated that being described as “substantially parallel extending” also is intended to encompass the side stands extending at a slight angle relative to one another. The orientation of the stand sides 84 of the stand 20 will closely match the orientation of the sides 46 of the mounting portion 46 of the trailer hitch coupler 22.

At least a portion of each of the pair of stand sides 84 are located on the base 80 and spaced apart a distance to engage and support a respective exterior side 46 of the mounting portion 42 of the trailer hitch coupler 22. As illustrated in FIG. 2, the stand sides 84 tightly engage the sides 46 of the mounting portion 42 of the trailer hitch coupler 22. The height that the stand sides 84 extend from the base 80 is a sufficient dimension to block lateral movement of the trailer hitch coupler 22 in the stand 20. The stand sides 84 also aid in supporting the trailer hitch coupler 22 and maintaining the trailer hitch coupler in a desired position relative to the base 80 and the stand 20. It will be apparent that the stand sides 84 could be located on the base 80 and spaced apart a distance to engage an interior surface of the sides 46 of the mounting portion 46 of the trailer hitch coupler 22.

The base 80 of the stand 20 also has a stand attachment portion 86 extending from the base in the same direction as the stand sides 84. The stand attachment portion 86 is located at least partially between the stand sides 84. In one specific example, the stand attachment portion 86 extends entirely between the stand sides 84 and is fixed to the stand sides to provide additional structural strength of the stand 20. The stand attachment portion 86 is located on the base 80 to engage an exterior surface of the span 48 of the mounting portion 42 of the trailer hitch coupler 22. It will be apparent that the stand attachment portion 86 could be located on the base 80 to engage an interior surface of the span 48 of the mounting portion 42 of the trailer hitch coupler 22. It will also be apparent that the stand attachment portion 86 could be located on at least one stand side 84 of the stand 20 to engage a side 46 of the mounting portion 42 of the trailer hitch coupler 22.

The stand attachment portion 86 includes locking structure 100 for retention interaction with the attachment structure 60 of the mounting portion 42 of the trailer hitch coupler 22. The locking structure 100 is resiliently deformable and deforms from an initial position, as illustrated in FIG. 3, in a direction towards the hollow portion 83 as the trailer hitch coupler 22 is moved into the stand 20 to connect the trailer hitch coupler with the stand. When the trailer hitch coupler 22 is moved all the way into the stand 20, the locking structure 100 returns to its initial position in order to retain the trailer hitch coupler within the stand. The plastic material that the stand 20 is made from allows the locking structure 100 to deform and accept the trailer hitch coupler 22.

The locking structure 100 includes a tab 102 extending orthogonally from the locking structure and away from the hollow portion 83 of the stand 20. The tab 102 and locking structure 100 resiliently deform from the initial position as the trailer hitch coupler 22 is inserted into the stand 20. The tab 102 and locking structure 100 then resiliently return to its initial position to engage an inner surface of an opening of the attachment structure 60 of the trailer hitch coupler 22 to retain the trailer hitch coupler in the stand 20. The size and shape of the tab 102 of the locking structure 100 closely matches the size and shape of the opening of the attachment structure 60. It will be apparent that the size and shape of the tab 102 of the locking structure 100 and the opening of the attachment structure 60 could be of any suitable size and shape. Also, it will be apparent that a different locking structure could be provided (e.g., a pin, a tie, fastener or the like).

When it is desired to remove the trailer hitch coupler 22 from the stand 20, such as after purchase and before attachment to a trailer frame, tab 102 of the locking structure 100 may be disengaged from the opening of the attachment structure 60. The locking structure 100 may be released from engagement from the opening of the attachment structure 60 by a finger or with a suitable tool. For example, the locking structure 100 can be moved away from its initial position so that the tab 102 is no longer with in and engaged with the opening of the attachment structure 60 of the mounting portion 42 of the trailer hitch coupler 22. The trailer hitch coupler 22 can then be removed from the stand 20.

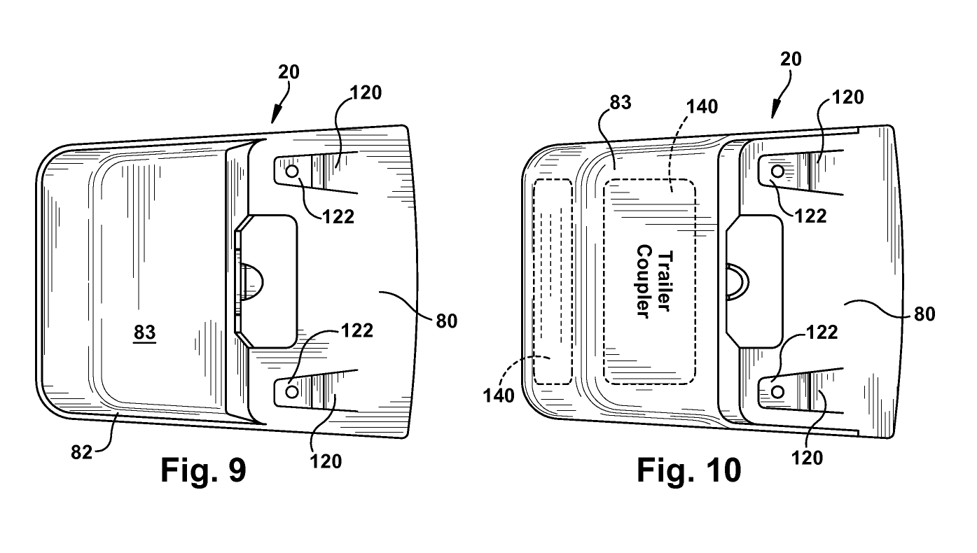

The stand 20 further includes support structure 120 (FIGS. 2, 3, 4, 8, 9 and 10 extending from the base 80 in the same direction as the stand sides 84. In one specific example, the support structure 120 is located to engage an interior portion of the trailer hitch coupler 22 to position the attachment structure 60 of the mounting portion 48 of the trailer hitch coupler to interact with the locking structure 100 and tab 102 of the stand 20. It will be apparent that the support structure 120 could be located on the base 80 in a position to engage and support an exterior surface of the mounting portion 42 of the trailer hitch coupler 22. However, the support structure 120 will always be located on the opposite side of the mounting portion 42 of the trailer hitch coupler 22 than the stand sides 84 and/or stand attachment portion 86.

In one specific example, the support structure 120 is in the form of a pair of substantially hollow and spaced apart supports 122. Each of the supports 122 are located on the base 80 to engage an interior surface of a respective side 48 of the mounting portion 42 of the trailer hitch coupler 22 and the span 48 of the mounting portion of the trailer hitch coupler. As illustrated in FIG. 2, the supports 122, stand sides 84 and the attachment portion 86 of the stand 20 tightly fit opposite surfaces of the mounting portion 42 of the trailer hitch coupler 22.

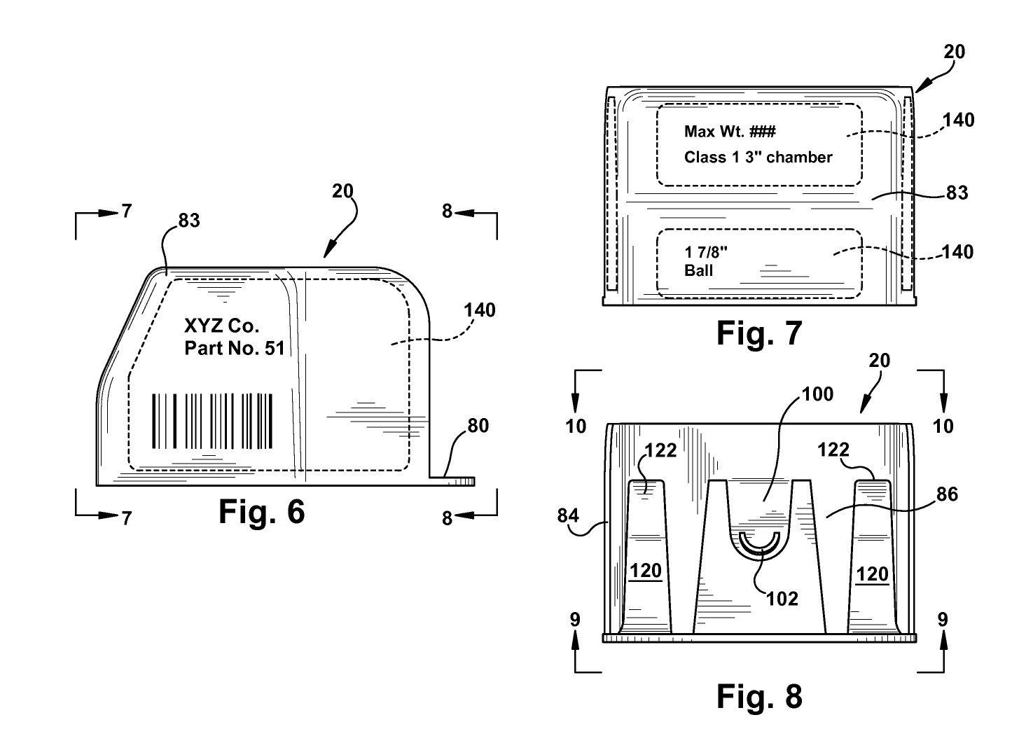

The stand 20 also includes one or more labels 140 (best seen in FIGS. 6, 7 and 10) that are intended to provide useful information about the trailer hitch coupler 22. Such information may include identifying indicia such as the name of the manufacturer, product trade name, a UPC barcode, class of the hitch, size of the ball receiving portion, maximum weight, and the size of the frame that the trailer hitch coupler 22 is to be attached.

When the trailer hitch coupler 22 is assembled with the stand 20, the axis A of the trailer hitch coupler 22 extends in an orthogonal direction relative to, and generally perpendicular to, the base 80 of the stand 20. Since the base 80 of the stand 20 is adapted to be supported on a substantially horizontal surface, the longitudinal extent and axis A of the trailer hitch coupler 22 extends in substantially a vertical direction, as illustrated in FIGS. 1 and 3.

In one specific example, the base 80 of the stand 20 extends in at least one direction substantially perpendicular to the longitudinal axis A of the trailer hitch coupler 22 for a distance E_{B} (FIG. 3) that is greater than the depth ID of the trailer hitch. The cover portion 83 of the stand 20 extends in a direction from the base 84 a distance E_{L} that is greater than the dimension that the trailer hitch coupler 22 extends above it. For example, the dimension that a closed condition ball receiving retainer mechanism 44 extends away from the ball receiving portion 40 of the trailer hitch coupler 22.

Thus, the stand 20 has the center of gravity of the standing trailer hitch coupler 22 located between the length L (FIG. 2) of the stand. This assembled arrangement enables a more attractive and orderly display arrangement of multiple trailer hitch couplers 22 on a shelf of a retail merchandising display. This assembled arrangement will also tend to resist movement of the trailer hitch coupler 22 from the substantially vertical orientation when it is on display on the retail merchandising shelf.

Since multiple assemblies of stands 20 and trailer hitch couplers 22 are displayed on the retail merchandising shelf in an upright and spaced apart relationship, there is a minimal chance that a particular trailer hitch coupler 22 will contact other trailer hitch couplers. Thus, the labels 140 attached to the stands 20 are sufficiently protected so that little or no damage may occur that may render them unreadable.

Although the description has been shown and described with respect to one or more embodiments, aspects or implementations, it will occur to those skilled in the art based upon a reading and understanding of this description and the annexed drawings that equivalent alterations and modifications may be made without detracting from the spirit and scope of the embodiments, aspects or implementations in the description. The description and claims are intended to include all such modifications and alterations.

What is claimed is:

1. A stand for a trailer hitch coupler, the trailer hitch coupler having a ball receiving portion and a mounting portion extending from the ball receiving portion, the mounting portion having a pair of substantially parallel extending sides connected by a span, the mounting portion also having attachment structure enabling attachment to a trailer frame, the stand comprising:
a base;
a pair of substantially parallel stand sides extending from the base, at least a portion of each of the pair of stand sides located to engage a respective side of the mounting portion of the trailer hitch coupler;
a stand attachment portion extending from the base in the same direction as the stand sides, the stand attachment portion located to engage a surface of the mounting portion of the trailer hitch coupler; and
locking structure for interaction with the attachment structure of the mounting portion of the trailer hitch coupler to attach the stand to the trailer hitch coupler and support the trailer hitch coupler in a predetermined relationship with the stand.

2. The stand of claim 1 wherein the locking structure is located on the stand attachment portion of the stand.

3. The stand of claim 1 wherein the locking structure releasably attaches the stand with the trailer hitch coupler.

4. The stand of claim 1 wherein the locking structure resiliently deforms to engage attachment structure of the trailer hitch coupler when the trailer hitch coupler is received in the stand.

5. The stand of claim 1 wherein the stand attachment portion extends between and connects the stand sides.

6. The stand of claim 1 wherein the stand attachment portion is at least partially located between the stand sides for engagement with the span of the mounting portion of the trailer hitch coupler.

7. The stand of claim 1 further including support structure extending from the base in the same direction as the stand sides, the support structure located to engage a surface of the span of the mounting portion of the trailer hitch coupler opposite the stand attachment portion of the stand to position the attachment structure of the mounting portion of the trailer hitch coupler for interaction with the locking structure of the stand.

8. The stand of claim 7 wherein the support structure includes a pair of spaced apart supports, each of spaced apart supports located to engage a surface of a respective side of the mounting portion of the trailer hitch coupler and a surface of the span.

9. The stand of claim 1 wherein the stand is constructed of a molded plastic material.

10. The stand of claim 1 wherein the trailer hitch coupler has a longitudinal extent that is adapted to extend in an orthogonal direction from the base when the trailer hitch coupler is disposed in the stand.

11. The stand of claim 10 wherein the base is adapted to be supported on a substantially horizontal surface with the longitudinal extent of the trailer hitch coupler extending in a substantially vertical orientation, and wherein the base extends in a first direction substantially perpendicular to the longitudinal extent of the trailer hitch coupler for a distance that is greater than the dimension that the trailer hitch coupler extends in the first direction to resist movement of the trailer hitch coupler from the substantially vertical orientation.

12. A stand for a trailer hitch coupler, the trailer hitch coupler having a ball receiving portion and a mounting portion extending from the ball receiving portion, the mounting portion having a pair of substantially parallel extending sides connected by a span, the mounting portion also having attachment structure enabling attachment to a trailer frame, the stand comprising:
a base;
a pair of substantially parallel stand sides extending from the base, each of the pair of stand sides adapted to engage a respective exterior side of the mounting portion;
a stand attachment portion extending from the base in the same direction as the stand sides and located between the stand sides connecting the stand sides, the stand attachment portion adapted to engage the exterior of the span of the mounting portion of the trailer hitch coupler;
interior support structure extending from the base in the same direction as the stand sides, the interior support structure is located to engage an interior surface of the mounting portion of the trailer hitch coupler; and
resiliently deformable locking structure on the stand attachment portion for interaction with the attachment structure of the mounting portion of the trailer hitch coupler when the trailer hitch coupler is received by the stand.

13. The stand of claim 12 wherein the locking structure releasably attaches the stand with the trailer hitch coupler.

14. The stand of claim 12 wherein the stand is constructed of a molded plastic material.

15. The stand of claim 12 wherein the trailer hitch coupler has a longitudinal extent that is adapted to extend in an orthogonal direction from the base when the trailer hitch coupler is disposed in the stand.

16. The stand of claim 15 wherein the base is adapted to be supported on a substantially horizontal surface with the longitudinal extent of the trailer hitch coupler extending in a substantially vertical orientation, and wherein the base extends in a first direction substantially perpendicular to the longitudinal extent of the trailer hitch coupler for a distance that is greater than the dimension that the trailer hitch coupler extends in the first direction to resist movement of the trailer hitch coupler from the substantially vertical orientation.

17. Apparatus comprising:
a trailer hitch coupler including:
a ball receiving portion: and
a mounting portion extending from the ball receiving portion, the mounting portion having a pair of substantially parallel extending sides connected by a span, the mounting portion also having attachment structure enabling attachment to a trailer frame; and
a stand including:
a base;
a pair of substantially parallel stand sides extending from the base, each of the pair of stand sides adapted to engage a respective exterior side of mounting portion of the trailer hitch coupler;
a stand attachment portion extending from the base in the same direction as the stand sides, the stand attachment portion adapted to engage the exterior of the span of the mounting portion of the of the trailer hitch coupler; and
locking structure for interaction with the attachment structure of the mounting portion of the trailer hitch coupler whereby the trailer hitch coupler is supported to extend in an orthogonal direction from base.

18. The stand of claim 17 further including interior support structure extending from the base in the same direction as the stand sides, the interior support is located to engage an interior surface of the mounting portion of the trailer hitch coupler.

19. The stand of claim 17 wherein the stand is constructed of a molded plastic material.

20. The stand of claim 17 wherein the base is adapted to be supported on a substantially horizontal surface with the longitudinal extent of the trailer hitch coupler extending in a substantially vertical orientation, and wherein the base extends in a first direction substantially perpendicular to the longitudinal extent of the trailer hitch coupler for a distance that is greater than the dimension that the trailer hitch coupler extends in the first direction to resist movement of the trailer hitch coupler from the substantially vertical orientation.
